(19) United States
(12) Patent Application Publication
(10) Pub. No.: US 2008/0032632 A1
(43) Pub. Date: Feb. 7, 2008

(54) APPARATUS AND METHOD FOR CANCELING INTERFERENCE IN A WIRELESS COMMUNICATION SYSTEM

(75) Inventors: Soong-Yoon CHOI, Suwon-si (KR); Young-Hoon KWON, Seongnam-si (KR); Sang-Boh YUN, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/834,788

(22) Filed: Aug. 7, 2007

(30) Foreign Application Priority Data
Aug. 7, 2006 (KR) 2006-0074091

(51) Int. Cl. H04B 17/00; H04B 1/00; H04L 12/28; H04M 1/00

(52) U.S. Cl. 455/63.1; 455/501; 455/509; 455/561; 455/67.13

(57) ABSTRACT

An apparatus and method for canceling interference from other MSs in an space-division wireless communication system are provided. The apparatus and method include a subframe for transmitting control information from a BS to MSs which is configured in a first region of the frame, and a subframe for transmitting and receiving signals between the BS and the MSs which is configured in a second region of the frame. The apparatus and method reduce consumption of time and frequency resources in a wireless communication system.

### PRIORITY

This application claims the benefit under 35 U.S.C. § 119(a) of a Korean patent application filed in the Korean Intellectual Property Office on Aug. 7, 2006 and assigned Serial No. 2006-0074091, the entire disclosure of which is hereby incorporated by reference.

### BACKGROUND OF THE INVENTION

1. Field of the Invention

The present invention relates generally to an apparatus and method for conducting communications in Space Division Duplexing (SDD) in a wireless communication system. More particularly, the present invention relates to an apparatus and method for canceling interference involved in SDD communications in a wireless communication system.

2. Description of the Related Art

The two most prevalent duplexing schemes used in wireless communication systems are Frequency Division Duplexing (FDD) and Time Division Duplexing (TDD) which differ in a criterion for distinguishing an uplink from a downlink.

In TDD, the downlink and the uplink are defined in time and thus use the same frequency. A TDD wireless communication system may be configured as illustrated in FIG. 1.

FIG. 1 is a block diagram illustrating a conventional TDD apparatus, herein a TDD Base Station (BS).

Referring to FIG. 1, a BS 100 includes a transmitter 101, a receiver 103, a switch 105, and an antenna 107.

The switch 105 switches signals to the transmitter 101 and the receiver 103 during downlink and uplink periods so that the transmitter 101 and the receiver 103 can share the antenna 107. For example, the switch 105 switches a signal received through the antenna 107 to the receiver 103 during the uplink period and switches a signal received from the transmitter 101 to the antenna 107 during the downlink period.

The transmitter 101 processes the transmission signal and provides it to the switch 105 in the downlink period, whereas the receiver 103 processes the signal received from the switch 105 in the uplink period.

In FDD, the downlink and uplink are distinguished in frequency and thus use the same time resources. An FDD wireless communication system may be configured as illustrated in FIG. 2.

FIG. 2 is a block diagram illustrating a conventional FDD apparatus, herein a FDD BS.

Referring to FIG. 2, a BS 200 includes a transmitter 201, a receiver 203, a duplexer 205, and an antenna 207.

The duplexer 205 duplexes a transmission frequency and a reception frequency and provides them to the transmitter 201 and the receiver 203 so that the transmitter 201 and the receiver 203 can share the antenna 207.

The transmitter 201 processes a transmission signal in a first frequency and provides it to the duplexer 205, whereas the receiver 203 processes a signal received in a second frequency from the duplexer 205.

TDD and FDD have their own different characteristics. For example, TDD boasts of high frequency use efficiency despite the disadvantage of high scheduling complexity due to the use of the same frequency on the downlink and the uplink. In FDD, although the use of the same frequency on the downlink and the uplink obviates the need for guard bands, guard intervals are required for as much round trip delay or switching delay between the downlink and the uplink.

As described above, TDD and FDD offer their benefits and suffer their shortcomings. TDD is advantageous in frequency efficiency, while FDD is advantageous in time resource efficiency and ease of scheduling. On the other hand, shortcomings with TDD are high scheduling complexity and time resources consumption caused by the use of guard intervals, whereas FDD suffers from low frequency resource efficiency because of the use of different frequencies for downlink and the uplink transmissions and frequency resource consumption caused by the use of guard bands.

### SUMMARY OF THE INVENTION

An aspect of the present invention is to address at least the above problems and/or disadvantages and to provide at least the advantages described below. Accordingly, an aspect of the present invention is to provide an apparatus and method for reducing consumption of time and frequency resources in a wireless communication system.

Another aspect of the present invention is to provide an apparatus and method for reducing consumption of time and frequency resources by SDD in a wireless communication system.

A further aspect of the present invention is to provide an apparatus and method for canceling interference involved in SDD communications in a wireless communication system.

Still another aspect of the present invention is to provide an apparatus and method for canceling interference from neighbor Mobile Stations (MSs) during SDD communications in a wireless communication system.

According to an aspect of the present invention, a method for configuring a frame in a wireless communication system is provided. The method includes configuring a subframe for transmitting control information from a BS to MSs in a first region of a frame and configuring a subframe for transmitting and receiving signals between the BS and the MSs in a second region of the frame.

According to another aspect of the present invention, a method for canceling interference in a BS in a wireless communication system is provided. The method includes monitoring information about statuses of MSs within a service area of the BS, generating control information including the status information and transmitting the control information to the MSs and transmitting and receiving signals to and from the MSs by dividing spatial resources.

According to a further aspect of the present invention, a method for canceling interference in an MS in a wireless communication system is provided. The method includes monitoring information about statuses of other MSs received from a BS and canceling interference from the other MSs in a signal received from the BS according to the status information.

According to still another aspect of the present invention, an apparatus of a BS in a wireless communication system is provided. The apparatus includes a status information monitor for monitoring information about a status of at least one MS within a service area of the BS, a scheduler for controlling communications with an MS by spatial resources and a transmitter for transmitting the status information of the at least one MS and a transmission signal to the MS under the control of the scheduler.

According to yet another aspect of the present invention, an apparatus of an MS in a spatial-division wireless communication system is provided. The apparatus includes a receiver for receiving information about statuses of neighbor MSs and a downlink signal from a BS and an interference canceller for canceling interference from the neighbor MSs included in a downlink signal received from the BS using the status information.

### BRIEF DESCRIPTION OF THE DRAWINGS

The above and other aspects, features and advantages of exemplary embodiments of the present invention will become more apparent from the following detailed description when taken in conjunction with the accompanying drawings in which:

FIG. 1 is a block diagram illustrating a conventional TDD apparatus;

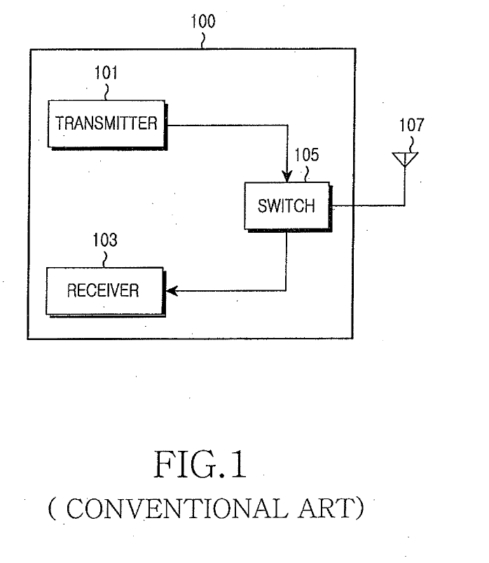

FIG. 2 is a block diagram illustrating a conventional FDD apparatus;

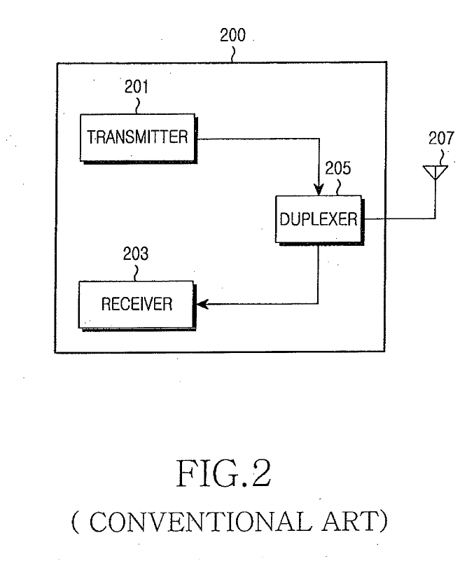

FIG. 3 is a block diagram illustrating an SDD apparatus according to an exemplary embodiment of the present invention;

FIG. 4 is a block diagram illustrating an apparatus for canceling interference from a transmit antenna according to an exemplary embodiment of the present invention;

FIG. 5 is a block diagram illustrating an apparatus for canceling interference from a transmit antenna according to another exemplary embodiment of the present invention;

FIG. 6 is a block diagram illustrating an apparatus for canceling interference from a transmit antenna according to a exemplary embodiment of the present invention;

FIG. 7 illustrates a frame structure designed for canceling interference from neighbor MSs according to an exemplary embodiment of the present invention;

FIG. 8 is a diagram illustrating timings for canceling interference from neighbor MSs according to an exemplary embodiment of the present invention;

FIG. 9 is a flowchart illustrating an operation of a BS for canceling interference from neighbor MSs according to an exemplary embodiment of the present invention;

FIG. 10 is a flowchart illustrating an operation of an MS for canceling interference from neighbor MSs according to an exemplary embodiment of the present invention;

FIG. 11 is a block diagram illustrating a BS for canceling interference from neighbor MSs according to an exemplary embodiment of the present invention; and

FIG. 12 is a block diagram illustrating a MS for canceling interference from neighbor MSs according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a technique for canceling interference involved in space-division-based signal transmission and reception in a wireless communication system. Additional exemplary embodiments of the present invention provide a technique for canceling interference from neighbor MSs during SDD communications in a wireless communication system.

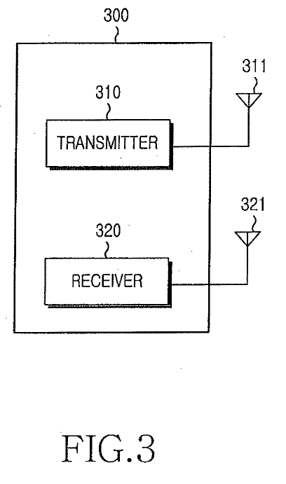

FIG. 3 is a block diagram illustrating an SDD apparatus according to an exemplary embodiment of the present invention. While the SDD apparatus is described below in the context of a BS, the present invention may be applied to an MS.

Referring to FIG. 3, a BS 300 includes a transmitter 310, a receiver 320, a first antenna 311 and a second antenna 321.

The transmitter 310 processes a transmission signal and transmits it to an MS through the first antenna 311. The receiver 320 recovers original data by detecting and decoding a signal received though the second antenna 321.

During the transmission and the reception, the transmitter 310 and the receiver 320 use time and frequency resources independently because the downlink and the uplink are separated spatially in SDD.

Therefore, the transmitter 310 continuously transmits signals through the first antenna 311 and the receiver 320 continuously receives signals through the second antenna 321.

In the above-described exemplary embodiment of the present invention, the transmitter 310 and the receiver 320 use different antennas. Meanwhile, it can be further contemplated as another exemplary embodiment that the transmitter 310 and the receiver 320 share one or more antennas.

As described above, an SDD wireless communication system separates the downlink and the uplink by spatial resources. Hence, time and frequency resources are used for the downlink and the uplink, independently, which enables continuous signal transmission/reception on the downlink and the uplink. However, a transmission signal may interfere with a received signal in SDD communications. For instance, a transmission signal directed to the first antenna 311 (i.e. transmit antenna) may be introduced into the second antenna 321 (i.e. receive antenna), acting as noise to a received signal in the BS having the configuration illustrated in FIG. 3.

Now, a description will be made of a method for canceling interference between a transmit antenna and a receive antenna residing in the same apparatus in the wireless communication system. While the interference cancellation method is described in the context of an SDD BS, the present invention may be applied to an MS.

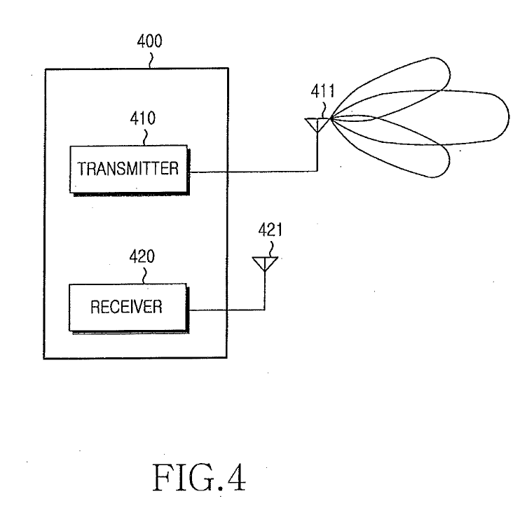

FIG. 4 is a block diagram illustrating an apparatus for canceling interference from a transmit antenna according to an exemplary embodiment of the present invention.

Referring to FIG. 4, a BS 400 includes a transmitter 410, a first antenna (transmit antenna) 411, a receiver 420 and a second antenna (receive antenna) 421. The transmitter 410 continuously transmits signals through the first antenna 411 and the receiver 420 continuously receives signals through the second antenna 421.

In order to prevent a signal that is to be transmitted through the first antenna 411 from being introduced into the second antenna 421, the first antenna 411 is configured to be a directional antenna. Also, the second antenna 421 may be positioned opposite to the direction of the first antenna 411, that is, behind the first antenna 411. A directional antenna is defined as an antenna that directs a signal in an intended direction.

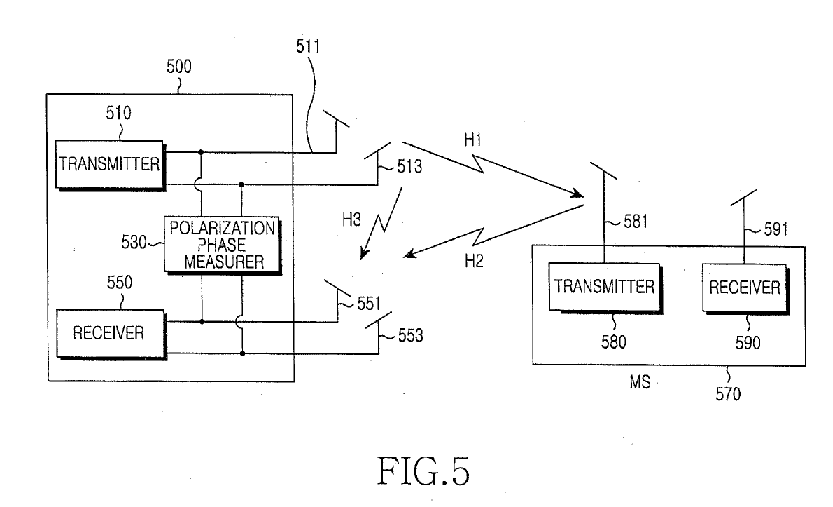

FIG. 5 is a block diagram illustrating an apparatus for canceling interference from a transmit antenna according to another exemplary embodiment of the present invention.

Referring to FIG. 5, a BS 500 includes a transmitter 510, a polarization phase measurer 530, a receiver 550, and a plurality of antennas 511, 513, 551 and 553. These antennas 511, 513, 551 and 553 are polarization antennas. A polarization antenna is an antenna that transmits/receives a signal by adjusting the polarization phase between a transmit antenna and a receive antenna according to the polarization characteristics of a transmission/received signal.

The transmitter 510 transmits signals through first and second antennas 511 and 513 and the receiver 550 receives signals through third and fourth antennas 551 and 553.

The polarization phase measurer 530 determines the phases of signals received through the third and fourth antennas 551 and 553 by analyzing them. Then the polarization phase measurer 530 controls the phases of signals to be transmitted through the first and second antennas 511 and 513 to be orthogonal to those of the received signals.

For example, the polarization phase measurer 530 determines the polarization phases of signals received on a channel h2 through the third and fourth antennas 551 and 553 and controls the polarization phases of transmission signals directed to the third and fourth antennas 551 and 553 so that the polarization phases of the transmission signals introduced to the third and fourth antennas 551 and 553 on a channel h3 are orthogonal to those of the signals received on the channel h2. As a result, interference between the transmit antennas 511 and 513 and the receive antennas 551 and 553 is cancelled.

An MS 570 includes a transmitter 580, a receiver 590, a fifth antenna 581 and a sixth antenna 591. The transmitter 580 transmits signals through fifth antenna 581 and the receiver 590 receives signals through sixth antenna 591. The fifth and sixth antennas 581 and 591 are polarization antennas. That is, the fifth and sixth antennas 581 and 591 are configured to have mutually orthogonal polarization characteristics for communications between the MS 570 and the BS 500.

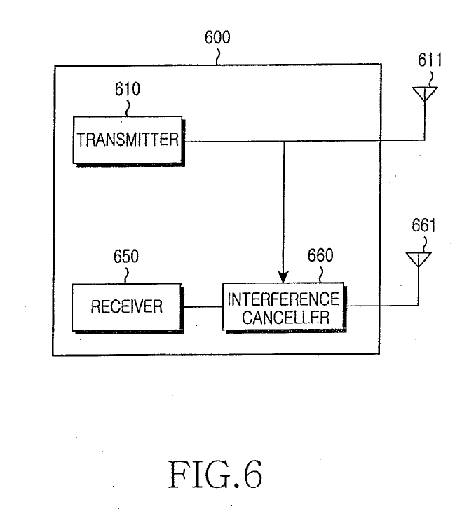

FIG. 6 is a block diagram illustrating an apparatus for canceling interference from a transmit antenna according to an exemplary embodiment of the present invention.

Referring to FIG. 6, a BS 600 includes a transmitter 610, a receiver 650, an interference canceller 660 and a plurality of antennas 611 and 661.

The transmitter 610 transmits a signal through a first antenna 611 and the interference canceller 660 receives the signal directed to the first antenna 611.

The receiver 650 receives a signal through a second antenna 661. Since the interference canceller 660 has knowledge of the transmission signal to be transmitted through the first antenna 611, it removes the transmission signal from the signal received through the second antenna 661, thus canceling interference between the first and second antennas 611 and 661.

Also, the BS 600 can reduce the interference between the first and second antennas 611 and 661 by positioning them far from each other.

The SDD wireless communication system can cancel interference between a transmit antenna and a receive antenna residing in the same apparatus using the above-described methods. Meanwhile, in the case where a service is provided to multiple users, the MS of a user may be interfered with by other MSs. That is, a signal transmitted from the MS of a first user may interfere with a signal received at the MS of a second user.

Hence, an exemplary technique for canceling interference from transmit antennas of neighbor MSs in the wireless communication system will be described below.

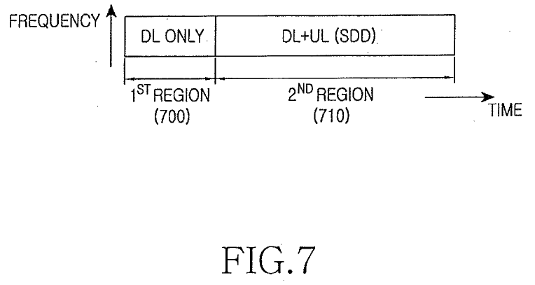

For cancellation of interference from transmit antennas of neighbor MSs, the wireless communication system may use a frame configured as illustrated in FIG. 7.

FIG. 7 illustrates a frame structure designed for canceling interference from neighbor MSs according to an exemplary embodiment of the present invention.

Referring to FIG. 7, a frame includes a first region 700 carrying control information from a BS to MSs and a second region 710 carrying signals between the BS and the MSs in SDD. The first and second regions 700 and 710 are separated by time resources.

In the first region 700, the BS transmits the control information to the MSs within its service area. The control information includes the positions of the MSs, a pilot signal, and time allocation information for each MS.

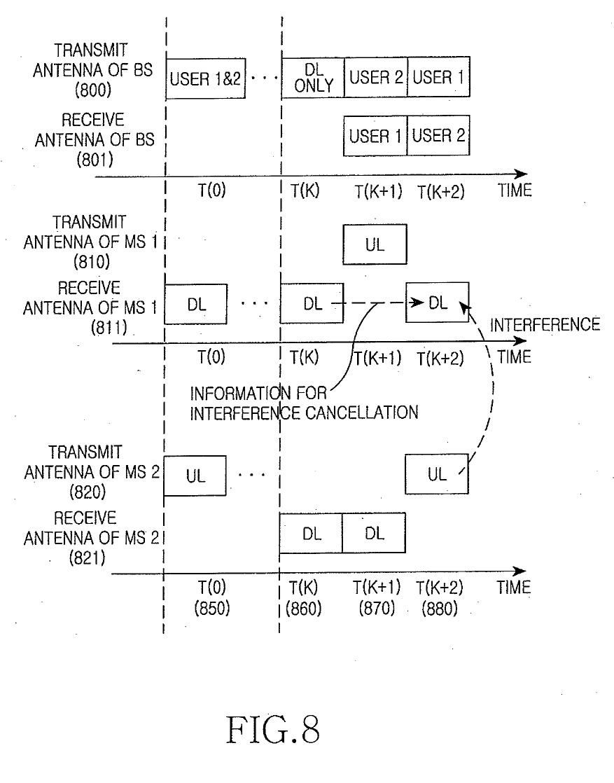

In the second region 710, the BS and the MSs exchange signals in SDD. As will be illustrated in FIG. 8, the signal transmission and reception is carried out based on time allocation information. The MSs cancel interference from their neighbor MSs using the control information received from the BS in the first region 700.

FIG. 8 is a diagram illustrating timings for canceling interference from neighbor MSs according to an exemplary embodiment of the present invention. While the following description is made under the assumption that the wireless communication system is comprised of a BS and first and second MSs (MS 1 and MS 2 or User 1 and User 2), the same thing applies to the case of more MSs.

Referring to FIG. 8, the BS transmits control information to MS 1 and MS 2 through a transmit antenna 800 at time T(0) 850. The control information includes the positions of the MSs, a pilot signal, and time allocation information for each MS. Thus, MS 1 and MS 2 receive the control information through receive antennas 811 and 821 at time T(K) 860.

At time T(K+1) 870, the BS transmits a signal to MS 2 through the transmit antenna 800 according to time allocation information, while receiving a signal from MS 1 through a receive antenna 801. That is, at time T(K+1) 870, MS 1 transmits the signal to the BS through a transmit antenna 810 and MS 2 receives the signal from the BS through the receive antenna 821. Simultaneously, the BS cancels interference introduced to the receive antenna 801 from the transmit antenna 800 using an exemplary method as illustrated in FIG. 4, 5, or 6.

The signal transmitted from the transmit antenna 810 of MS 1 interferes with the signal received at the receive antenna 821 of MS 2. Thus, MS 2 cancels the interference from MS 1 using status information about MS 1 received from the BS at time T(K) 860.

Finally at time T(K+2) 880, the BS transmits a signal to MS 1 through the transmit antenna 800 and receives a signal from MS 2 through the receive antenna 801. That is, at time T(K+2) 880, MS 2 transmits the signal to the BS through the transmit antenna 820 and MS 1 receives the signal from the BS through the receive antenna 811.

The signal transmitted from the transmit antenna 820 of MS 2 interferes the signal received at the receive antenna 811 of MS 1. Thus, MS 1 cancels the interference from MS 2 using status information about MS 2 received from the BS at time T(K) 860.

Operations of a BS and an MS that transmit and receive signals in a frame configured as illustrated in FIG. 7 will be described.

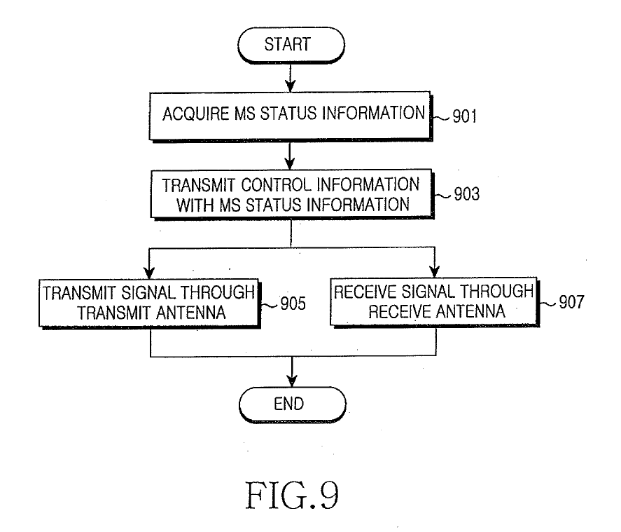

FIG. 9 is a flowchart illustrating an operation of a BS for canceling interference from neighbor MSs according to an exemplary embodiment of the present invention.

Referring to FIG. 9, the BS acquires information about the statuses of MSs within its service area in step 901 and transmits control information including the status information to the MSs in step 903. The control information includes the status information of the MSs, a pilot signal and time allocation information for each MS.

The BS transmits signals to the MSs through a transmit antenna in step 905 and receives signals from the MSs through a receive antenna in step 907. Since the downlink and the uplink are separated by spatial resources, signals are transmitted and received at the same time using time and frequency resources independently on the downlink and the uplink. When the BS provides a service to a plurality of MSs, it transmits and receives signals according to the time allocation information of each MS. For example, the BS transmits a signal to a first MS through the transmit antenna and receives a signal from a second MS through the receive antenna during a first time interval.

Then the BS ends the algorithm.

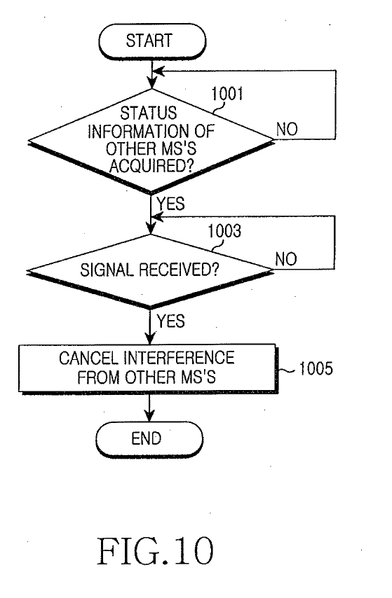

FIG. 10 is a flowchart illustrating an operation of an MS for canceling interference from neighbor MSs according to an exemplary embodiment of the present invention.

Referring to FIG. 10, the MS monitors reception of control information including information about the statuses of neighbor MSs from the BS in step 1001. For example, if communications are conducted in a frame having an exemplary configuration as illustrated in FIG. 7, the MS monitors the control information including the status information of the neighbor MSs from the BS in the first region 700.

Upon receipt of the control information, the MS monitors reception of a downlink signal from the BS in step 1003. Upon receipt of the downlink signal, the MS cancels interference from the neighbor MSs included in the received signal based on the status information of the neighbor MSs in step 1005.

Then, the MS ends the algorithm.

Now a description will be made below of exemplary structures of the BS and the MS for canceling interference from neighbor MSs in the wireless communication system.

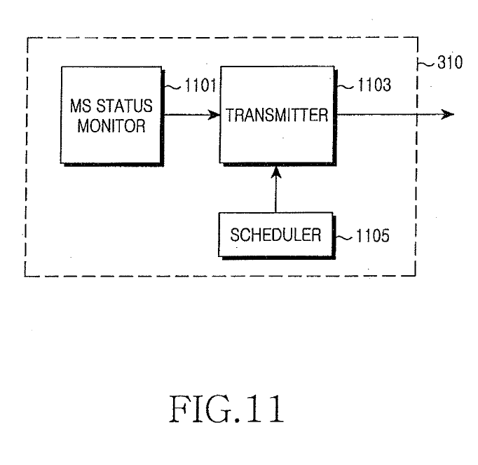

FIG. 11 is a block diagram illustrating a BS for canceling interference from neighbor MSs according to an exemplary embodiment of the present invention.

Referring to FIG. 11, in the BS, a transmitter 310 includes an MS status monitor 1101, a transmitter 1103, and a scheduler 1105.

The scheduler 1105 provides a timing signal to the transmitter 310, for transmitting a signal to an MS. For example, the scheduler 1105 provides a timing signal to the transmitter 310 so that the transmitter 310 transmits control information about information about the statuses of neighbor MSs at time T(K) 860 in FIG. 8. The scheduler 1105 also provide timing signals so that the transmitter 310 transmits a signal to MS 2 at time T(K+1) 870 and to MS 1 at time T(K+2) 880.

While not shown, the scheduler 1105 provides timing signals to the receiver 320 so that the receiver 320 can receive signals from MSs. For example, the scheduler 1105 provides a timing signal to the receiver 320 so that the receiver 320 receives a signal from MS 1 at time T(K+1) 870 and from MS 2 at time T(K+2) 880 in FIG. 8.

The MS status monitor 1101 acquires the status information of MSs within the service area of the BS and provides it to the transmitter 1103.

The transmitter 1103 transmits a signal through a transmit antenna under the control of the scheduler 1105. For instance, the transmitter 1103 transmits the control information including information about the statuses of the neighbor MSs at time T(K) 860 in accordance with a timing signal received from the scheduler 1105. The transmitter 310 also transmits a signal to MS 2 at time T(K+1) 870 and to MS 1 at time T(K+2) 880 in accordance with timing signals received from the scheduler 1105.

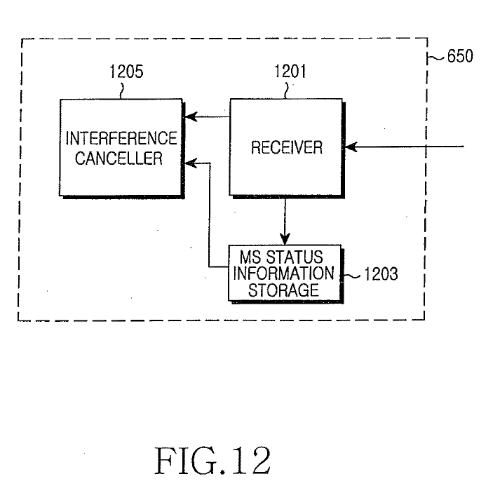

FIG. 12 is a block diagram illustrating an MS for canceling interference from neighbor MSs according to an exemplary embodiment of the present invention. The MS has substantially the same exemplary configuration as that of the BS illustrated in FIG. 6.

Referring to FIG. 12, in the MS, a reception part 650 includes a receiver 1201, an MS status information storage 1203, and an interference canceller 1205.

The receiver 1201 monitors a signal received from a receive antenna and provides the signal to the MS status information storage 1203 or the interference canceller 1205. For example, if communications are conducted in the manner illustrated in FIG. 8, upon receipt of control information including information about the statuses of neighbor MSs at time T(K) 860, the receiver 1201 provides the status information to the MS status information storage 1203. Also, the receiver 1201 provides a downlink signal received from the BS to the interference canceller 1205 to cancel interference from the neighbor MSs in the downlink signal.

The MS status information storage 1203 stores the status information received from the receiver 1201 and later provides it to the interference canceller 1205 so as to cancel the neighbor MSs′ interference from a received signal.

The interference canceller 1205 cancels the neighbor MSs′ interference from the downlink signal received from the receiver 1201 based on the status information received from the MS status information storage 1203.

While communications between an SDD BS and SDD MSs have been described above, communications can be conducted and interference can be cancelled in the same manner between an SDD BS and TDD or FDD MSs in other exemplary embodiments of the present invention. For example, the SDD BS uses time and frequency resources independently for a transmit antenna and a receive antenna. Therefore, when the SDD BS communicates with TDD MSs, it carries out transmission and reception independently in time. When the SDD BS communicates with FDD MSs, it carries transmission and reception independently in frequency.

As is apparent from the above description, exemplary embodiments of the present invention advantageously cancel interference from neighbor MSs based on information about the statuses of the neighbor MSs by providing the status information from a BS to each MS in an SDD wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for configuring a frame in a wireless communication system, the method comprising:
configuring a subframe for transmitting control information from a Base Station (BS) to Mobile Stations (MSs) in a first region of the frame; and
configuring a subframe for transmitting and receiving signals between the BS and the MSs in a second region of the frame.

2. The method of claim 1, wherein the first and second regions are separated by time resources in the frame.

3. The method of claim 1, wherein the control information comprises at least one of information about statuses of the MSs, a pilot signal, and time allocation information for each of the MSs.

4. The method of claim 1, where the configuring of the subframe in the second region of the frame comprises configuring a first subframe for transmitting signals to the MSs by the BS through a transmit antenna and a second subframe for receiving signals from the MSs by the BS through a receive antenna in the second region of the frame.

5. The method of claim 4, wherein the first and second subframes are separated by spatial resources.

6. A method for canceling interference in a Base Station (BS) in a wireless communication system, the method comprising:
monitoring information regarding a status of each of a plurality of Mobile Stations (MSs) within a service area of the BS;
generating control information including the status information and transmitting the control information to the plurality of MSs; and
transmitting and receiving signals to and from at least one of the plurality of MSs by dividing spatial resources.

7. The method of claim 6, wherein the control information comprises at least one of the status information of the plurality of MSs, a pilot signal, and time allocation information for each of the plurality of MSs.

8. The method of claim 6, wherein the transmitting and receiving comprises:
transmitting a signal to at least one MS through a transmit antenna according to time allocation information for each MS; and
receiving a signal from at least another one MS through a receive antenna according to the time allocation information, simultaneously with the signal transmission.

9. A method for canceling interference in a Mobile Station (MS) in a wireless communication system, the method comprising:
monitoring status information about at least one other Mobile Station (MS) received from a Base Station (BS); and
canceling interference from the at least one other MS in a signal received form the BS according to the status information.

10. The method of claim 9, wherein the monitoring comprises:
monitoring reception of control information from the BS; and
checking the status information of the at least one other MS included in the control information.

11. The method of claim 10, wherein the control information comprises at least one of the status information of the at least one other MS, a pilot signal, and time allocation information for each of the MSs.

12. An apparatus of a Base Station (BS) in a wireless communication system, comprising:
a status information monitor for monitoring information about status of at least one Mobile Station (MS) within a service area of the BS;
a scheduler for controlling communications with an MS by spatial resources; and
a transmitter for transmitting the status information of the at least one MS and a transmission signal to the MS under the control of the scheduler.

13. The apparatus of claim 12, wherein the scheduler provides a timing signal for transmitting and receiving signals in subframes configured using spatial resources according to a frame configuration method.

14. The apparatus of claim 13, wherein the scheduler provides a timing signal to the transmitter so that the transmitter transmits control information about the status information of the at least one MS to the MS in a first region of a frame, and provides a timing signal to the transmitter so that the transmitter transmits and receives signals to and from the MS in a second region of the frame.

15. The apparatus of claim 14, wherein the scheduler provides a timing signal for transmitting a signal to a first MS through a transmit antenna and receiving a signal from a second MS through a receive antenna in the second region of the frame.

16. The apparatus of claim 14, wherein the transmitter transmits the control information to the MS through a transmit antenna in the first region of the frame according to the timing signal received from the scheduler and transmits the signal to the MS through the transmit antenna in the second region of the frame according to time allocation information.

17. The apparatus of claim 12, further comprising a receiver for receiving a signal through a receive antenna according to a timing signal received from the scheduler.

18. The apparatus of claim 17, wherein the receiver receives a signal from the MS through the receive antenna in the second region of the frame in response to the timing signal received from the scheduler according to time allocation information.

19. An apparatus of a Mobile Station (MS) in a spatial-division wireless communication system, comprising:
a receiver for receiving status information about at least one neighbor MS and a downlink signal from a Base Station (BS); and
an interference canceller for canceling interference from the at least one neighbor MS included in a downlink signal received form the BS using the status information.

20. The apparatus of claim 19, further comprising a transmitter for transmitting a signal to the BS during the receiving of the downlink signal at the receiver.
